(19) United States
(12) Patent Application Publication
(10) Pub. No.: US 2018/0037417 A1
(43) Pub. Date: Feb. 8, 2018

(54) Device and method for increasing the safety of roller coasters and/or carousels

(71) Applicant: Mack Rides GmbH & Co. KG, Waldkirch (DE)

(72) Inventor: Roman Hauer, Waldkirch (DE)

(73) Assignee: Mack Rides GmbH & Co. KG, Waldkirch (DE)

(21) Appl. No.: 15/553,069

(22) PCT Filed: Feb. 17, 2016
(86) PCT No.: PCT/EP2016/053320

§ 371 Date: Aug. 23, 2017

(30) Foreign Application Priority Data
Feb. 23, 2015 (DE) 10 2015 102 556.6

(51) Int. Cl. B65G 43/02; G01M 17/08

(52) U.S. Cl. CPC B65G 43/02; G01M 17/08

(57) ABSTRACT

A device for increasing the safety of roller coasters and/or having at least one safety apparatus, wherein the safety apparatus has first means for the long-term measurement of at least one load in at least one component during the operation of an amusement ride and second means for detecting a change in the at least one load measured during the long-term measurement and for initiating at least one safety reaction at the roller coaster or the carousel. The disclosure further relates to a method for increasing the safety of amusement rides by means of at least one safety apparatus, wherein first means of the safety apparatus perform a long-term measurement of at least one load in at least one component during the entire operating duration of the amusement ride and second means detect a change in the at least one load measured during the long-term measurement, wherein the second means initiate an automatic safety reaction at the roller coaster and/or the carousel, which safety reaction depends on the change.

The present invention refers to a device and a method for increasing the safety of roller coasters and/or carousels according to the preamble of claims 1 and 14.

Monitoring systems that monitor wear of components in amusement rides are already known. EP 1 464 919 B1, for example, discloses a method and a device for monitoring the chain wear of chain drive units, which are used, for example, in transport systems such as lift constructions.

If the monitoring system according to the state of the art detects a change, such as a deterioration of a load capacity of a wear part, the known monitoring system usually sends, as a reaction, alarm signals to the operator.

A drawback is considered in that the known systems necessarily rely on wear, i.e. a removal of material. Changes of inner loads, such as stresses, for example, may however reach inadmissible values, without the material being worn. Such changes of loads are not detected by said monitoring systems.

Load measurements on amusement rides for verification of theoretical design loads are also known. Such measurements of the state of the art are only performed by snapshots, i.e. by a onetime measurement at a predetermined time or by performing a sequence of measurements during a specific period of time, usually zo before commissioning or after damage or accident has occurred.

A drawback is considered in that in known methods of load measurement a deterioration of safety is only temporarily detected, so that safety during the entire operation of the amusement ride cannot be guaranteed. Moreover, at the time of the one-time measurement, an advanced damage may already be present, the repair of which would have higher economic and operating consequences.

Moreover, in the state of the art, measurements of loads and their evaluation are performed by data acquisition systems, which are not connected to the control system of the amusement ride and whose results require human decisions.

It is considered a drawback that in known methods the required countermeasures are activated manually by the respective operator and with a time delay. In known load measurements, no automatic interface between the data acquisition and the control of the amusement ride is present.

The object of the invention is therefore to provide a safety system for roller coasters and/or carousels, in which loads are directly monitored on the amusement ride through a long-term measurement by a safety control, which is constantly active and can therefore detect a deterioration of the safety of the amusement ride at an early stage. Several weeks usually pass between the detection of an overloading condition and the beginning of material damage, so that the invention may also be considered as an early warning system, which provides additional flexibility in contrasting such hazards.

The object of the invention is achieved by a device for increasing the safety of roller coasters and/or carousels with the characteristics of claim 1 and by a method for increasing the safety of roller coasters and carousels with the characteristics of claim 14.

Advantageous embodiments and elaborations of the invention are provided in the dependent claims.

The device according to the invention for increasing the safety of roller coasters and/or carousels has at least one safety apparatus, wherein the safety apparatus has first means for the long-term measurement of at least one load in at least one component during the operation of a roller coaster and/or carousel and second means for detecting a change in the load and for initiating at least one reaction at the zo roller coaster and/or carousel.

Advantageously, the safety apparatus has second means for initiating at least one automatic safety reaction. By means of such an automation system, possible error sources during initiation of the safety reaction, such as a human error, may be reduced, increasing the effectiveness of the safety reactions.

The term “amusement ride” refers, as meant by the invention, to a roller coaster and/or carousel.

Here and in the following the term “long-time measurement” is intended to refer to a sequence of measurements during a long period of time of a variable to be measured and which may possibly change during the sequence of measurements, i.e. the measurement period, wherein the measurement may also be provided by individual measurements during the measurement period, which are performed in a random or periodic way. In an amusement ride, the measurement period may comprise, for example, the operating durations during the entire operating life of the amusement ride, wherein individual measurements are performed during a respective ride or in specific areas of the route.

The term “loads” refer, here and in the following, to effects of an external load, in the form, among other things, of a tensile or compressive stress or of a shear stress on the inside of a body or material. With such a safety apparatus, a deterioration of safety may be permanently detected over the entire life of the amusement ride, and measurements may be initiated in an automatic and controlled way. With such a safety apparatus, a reduction of the probability of a component's failure from “seldom or possible” to “unlikely or impossible” may be achieved.

The second means advantageously have at least one safety control for observing and detecting changes in loads. The safety control may be part of the system control of the roller coaster and/or carousel or an independent control, which, in the latter case, is in permanent communication with the system control. With such a safety control, the system control may react to changes in loads with different safety-oriented measures. If the safety control detects a change in the loads, it may send out an information or alarm, for example, wherein, in case of disregard of one or more alarms, the roller coaster and/or carousel may be stopped in a controlled way or an emergency stop may be activated. The respective reaction may involve an entire system or only a portion of the system, in which a change in the loads has been detected, such as a vehicle, for example.

The safety reaction is advantageously a part of a system control of the roller coaster and/or carousel, or is permanently communicating with the system control.

In a further embodiment of the invention, the safety reactions may be initiated depending on the change of the at least one load, which is measured during the long-term measurement and of its temporal profile with at least a safety oriented measure. In this way, for each change a specific safety reaction may be initiated, increasing the safety of the amusement ride as a whole.

According to a preferred embodiment of the invention, the first means have one or more data acquisition systems for long-term measurement. Data acquisition systems are advantageous in that they allow a further digital processing of measurement variables.

Preferably, the first means have at least one data acquisition system for long-term measurement of dilations, deformations, stresses, loads, accelerations or a combination of such measurements. Such loads are the most common loads in amusement rides.

The at least one component preferably comprises essentially at least one welded or not welded metal structure, at least one machine element, a plastic element, a composite component or a combination of said elements. In this case, composite components are components which are composed of a composite material, i.e. a material comprised of two or more connected materials, which have different properties than its individual components, such as carbon fiber reinforced plastic. In this way, all present component types of an amusement ride may be essentially detected, therefore reacting to changes in loads essentially in all parts of an amusement ride, with corresponding safety level.

The at least one machine element preferably essentially comprises at least one mechanically processed component, an axle, a shaft, a bearing, a wheel, a gear, a transmission, a coupling, a spring, a connection means or a combination of said components. In this way, almost all machine elements of an amusement ride may be detected.

Advantageously, the safety apparatus has first means for measuring a load profile of the component. Here and in the following, the term “load profile” refers to the temporal evolution of a load. Based on such a profile, deviations from a nominal range of a load may be detected in an early stage.

In a further embodiment of the invention, the first means of the safety apparatus are provided with at least one strain gauge, an acceleration sensor, a load detecting sensor, an optical sensor or a combination thereof. The loads may therefore be specifically detected through sensors.

The safety apparatus is advantageously applied on new amusement rides.

The safety apparatus may also be applied on existing systems.

In a preferred embodiment of the invention, the roller coaster and/or the carousel are operated as stationary amusement rides or as a temporarily flying structure. Therefore, the application field of the safety apparatus ranges from amusement parks to popular festivals.

The method according to the invention for increasing the safety of roller coasters and/or carousels is based on at least one of previously described safety apparatuses, wherein first means of the safety apparatus perform, during the entire operating duration of the amusement ride, a long-term measurement of at least one load in at least one component and wherein second means detect a change of the at least one load measured during the long-term measurement, wherein the second means initiate a reaction depending on the change.

Individual measurements are preferably performed during the long-term measurement in a random or periodic way, wherein periodic measurements take place at at least one determinable time over a period of one or more ride durations of the amusement ride or at a freely selectable recurrent time, for example according to a daily or weekly cycle.

The invention is explained in detail, by means of following figures. In particular:

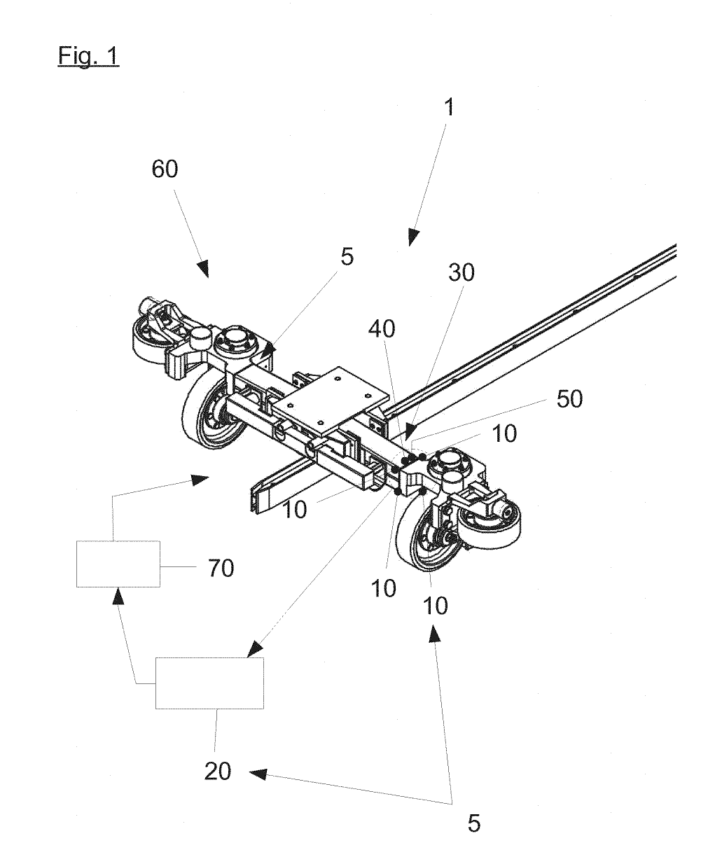

FIG. 1 shows an exemplary embodiment of a safety apparatus and

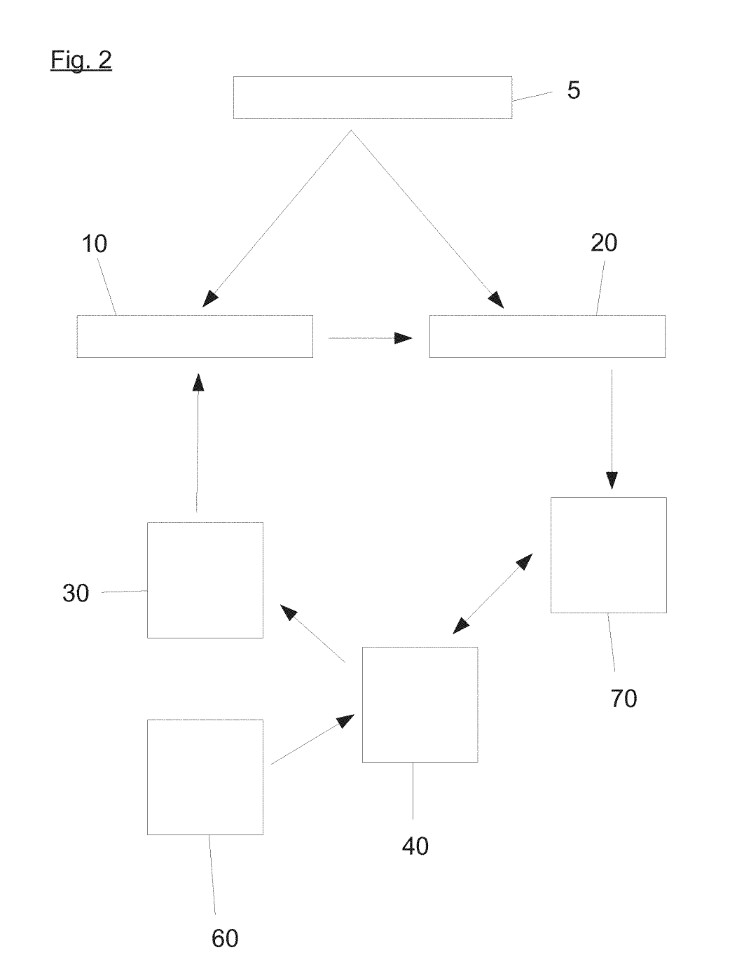

FIG. 2 shows an evolution diagram of an exemplary embodiment of a method for increasing the safety of amusement rides.

FIG. 1 shows a chassis of a vehicle of an amusement ride 60, such as a roller coaster. The chassis has one device 1 according to the invention. The device 1 comprises safety apparatuses 5 on components 40 of the amusement ride 60. FIG. 1 shows an example of components, on which a long-term measurement of loads 30 takes place, with a welded cuboid axle with a weld seam 50.

First means 10 of the safety apparatus 5 are positioned, as strain gauges, on the welding seam 50. FIG. 1 shows, as an example, four strain gauges, which are distributed along the periphery of the axle. The strain gauges detect dilations in the form of loads 30 exerted on the welding seam 50. The strain gauges may be active for the entire ride duration or only in specific areas of a route.

Based on calculations and/or measurements performed during the commissioning of the amusement ride 60, typical dilations or other loads 30 of the welding seam 50 or of another component 40 are known as numerical values. Based on these values, through a predetermined upper and lower limit, a nominal range may be defined.

The loads 30 measured during a travel of the amusement ride 60 or in specific areas of the route of amusement ride 60, such as dilations, may be compared, by second means 20 by means of safety controls, with a predetermined nominal range of values. If loads 30 lie inside the nominal range, the welding seam 50, or a correspondingly different component 40, may be loaded as planned. In this case, the second means 20 do not activate any safety reaction 70. If the measured loads 30 rise above or fall below the nominal range, an overloading or low loading of component 40 is present, In case of an overloading, an initial damage, such as a crack, may be possibly exist on the component 40. In this case, the safety controls of the second means 20 may react, through a system control, with suitable measures, providing a safety reaction 70. A safety reaction may, for example, comprise an alarm signal, wherein in case of disregard of several alarm signals, the amusement ride 60 or a portion of the amusement ride, such as a corresponding vehicle, may be deactivated in a controlled way.

Further safety reactions 70 by the system control may comprise, for example, is the provision of safety information and an emergency stop of the system.

The strain gauges may detect already dangerous dilations of the component 40 in an early stage thereof, before they lead to the formation of a crack.

FIG. 2 shows, as an example, the schematic evolution of the method for increasing the safety of amusement rides. The method is based on a safety apparatus 5 for long-term monitoring of a component 40 of an amusement ride 60, such as the one shown in FIG. 1.

The safety apparatus 5 has first means 10 for early sensor-based detection of a component overloading or low loading condition or of a component failure. The first means 10 may be provided as a data acquisition system, such as a strain gauge, an acceleration sensor, a load sensor, an optical sensor or a combination of said sensors. The optical sensor may be a light sensor, in particular a laser sensor. With such a sensor-based early detection a variety of loads 30 may be detected. Acceleration sensors may, for example, measure acceleration forces. The first means 10 may detect loads 30 in an amusement ride 60, as shown in FIG. 1. In particular, the first means 10 may be used in stationary amusement rides 60, for example in recreational parks, or on flying structures, such as the one used at popular festivals. Moreover, the first means 10 may be used not only on new amusement rides 60, but also on existing systems. In particular, the first means 10 may be used in components 40 of amusement rides 60, for example in metal structures, machine elements, mechanically processed components, axles, shafts, bearings, wheels, gears, transmissions, couplings, springs, connection means, plastic elements or composite components.

In the amusement ride 60 or in its components 40, the first means 10 measure loads 30 occurring during the operation of the amusement ride 60. During the operation of the amusement ride, loads 30 are in particular dilations, deformations, stresses, loads, or accelerations. These loads 30 may be continuously measured by the first means 10 during an arbitrarily long period of time. It is also possible to provide a load profile.

The safety apparatus 5 also has second means 20. The second means 20 record changes in the measured loads 30. The second means 20 have one or more safety controls. The safety controls are part of the system control or communicate with the same. The system control initiates one or more safety reactions 70 to a change in the load 30, which is detected by the safety control.

### LIST OF REFERENCES

1 device

5 safety apparatus

10 first means

20 second means

30 load

40 component

50 welding seam

60 amusement ride

70 safety reaction

1. A device for increasing the safety of amusement park ride, comprising:
a safety apparatus;
wherein the safety apparatus has a first means for the long-term measurement of a load in a component during operation of the amusement park ride; and
wherein the safety apparatus has a second means for detecting a change in the load measured during the long-term measurement and for initiating a safety reaction of the amusement park ride.

2. The device according to claim 1,
wherein the safety apparatus has second means for initiating at least one an automatic safety reaction.

3. The device according to claim 1,
wherein the second means have a safety control for monitoring and detecting changes in the load.

4. The device according to claim 3,
wherein the safety control is in communication with an amusement park ride system control.

5. The device according to claim 1,
wherein the safety reaction is automatically initiated, depending on the change in the one load, which is measured during the long-term measurement and on a temporal evolution with a safety-oriented measure on the amusement park ride.

6. The device of any of the preceding claims, according to claim 1,
wherein the comprises a data acquisition system for long-term measurement.

7. The device of according to claim 6,
wherein the data acquisition system for long-term measurement measures dilations, deformations, stresses, loads, accelerations or a combination thereof.

8. The device according to claim 1,
wherein the at least one component consisting essentially of a metal structure, a machine element, a plastic element, a composite component or a combination thereof.

9. The device according to claim 8,
wherein the machine element consisting essentially of a mechanically processed component, an axle, a shaft, a bearing, a wheel, a gear, a transmission, a coupling, a spring, a connection means or a combination thereof.

10. The device according to claim 1,
wherein the first means measures a load profile of the component.

11. The device according to claim 1,
wherein the first means comprises a strain gauge, an acceleration sensor, a load sensing sensor, an optical sensor or a combination thereof.

12. The device according to claim 1,
wherein the safety apparatus is adapted for retrofitting.

13. The device according to claim 1,
wherein the amusement park ride comprises a stationary amusement ride or as a temporarily flying structure.

14. A method for increasing the safety of an amusement park ride with at least one the safety apparatus according to claim 1,
wherein the first means of the safety apparatus performs, during an entire operation of the amusement ride, a long-term measurement of the load in the component and that the second means detects a change in the the load measured during the long-term measurement, wherein the second means initiates an automatic safety reaction at the amusement park ride, which safety reaction depends on the change.

15. The method of claim 14,
wherein individual measurements are randomly or periodically performed during the long-term measurement, wherein periodic measurements are performed at a determinable time during a period of a travel time of the amusement park ride or at a freely selectable recurrent time.

16. An amusement park ride system, comprising:
a safety apparatus coupled to a component of the amusement park ride, wherein the safety apparatus comprises:
a data acquisition system comprising a sensor, wherein the sensor measures long-term measurements of a load on the component during operation of the amusement park ride; and
a safety control system, wherein the safety control system compares the long-term measurements of the load on the component during operation of the amusement park ride to predetermined values and wherein the safety control system activates a safety reaction based on the long-term measurements.

17. The amusement park ride system of claim 16, wherein the safety control system activates a safety reaction based on comparing the long-term measurements of the load on the component during operation of the amusement park ride to predetermined values.

18. The amusement park ride system of claim 16, wherein the safety control system activates a safety reaction based on a temporal evolution of the load.
